(19) United States
(12) Patent Application Publication
(10) Pub. No.: US 2004/0107794 A1
(43) Pub. Date: Jun. 10, 2004

(54) High performance connecting rod and method for making

(76) Inventor: Kirk Wolfgang Jager, Jonesborough, TN (US)

Correspondence Address: Susan F. Johnston, Attorney at Law, P.O. Box 4449, Johnson City, TN, 37602-4449, US

(21) Appl. No.: 10/310,663

(22) Filed: Dec. 4, 2002

(51) Int. Cl. G05G 1/00

(52) U.S. Cl. 74/579 R

(57) ABSTRACT

The present connecting rod assembly has a configuration of a substantially parallel sided elongate member, and a pair of rod bolts positioned for fastening the cap to the elongate member disposed at a splayed angle with the longitudinal axis so as to decrease side-to-side movement of the connecting rod cap. The invention further includes electrochemically processing the aluminum alloy connecting rod components in order to form an aluminum oxide matrix on the surface, and sealing the interstitial cavities of the matrix with an inert fluoropolymer to thus provide a composite layer providing added surface hardness and lubricity in order to decrease seizing and deformation of the connecting rod during use.

### FIELD OF THE INVENTION

The present invention relates to the filed of high performance internal combustion engine connecting rods made from aluminum alloys.

### BACKGROUND OF THE INVENTION

Internal combustion engines utilized in the powering of high performance vehicles have pistons which reciprocate within cylinders that reside within a cylinder block. The pistons transfer combustion forces through the connecting rod into a geometrically complex crankshaft that converts the reciprocating motion of the pistons and connecting rods to rotational motion at the power output of the engine. The pistons are indirectly connected to the connecting rod via a cylindrical “wrist pin” received though a wrist pin bore running through one end of the connecting rod, the “pin end”. The crankshaft is indirectly connected to the connecting rod via a larger cylindrical rod journal received through a crank pin bore running through the opposite end of the connecting rod, the “crank end”. The crank end of the connecting rod typically contains an inserted bearing of some common bearing configuration.

As is commonly known, the crank end of the connecting rod is split into two separate connecting pieces along an interface for installation purposes. This interface divides the cylindrical bearing bore at the crank end of the connecting rod into two pieces, a forked elongate body which includes the pin bore and a corresponding arcuate cap. The cap is typically fastened against the forked elongate body by two oppositely positioned rod bolts that pass through the cap, seat on hardened washers, and thread into aligned threaded holes in the fork end of the elongate body.

High performance internal combustion engines place much strain and stress on presently used connecting rods. It is well known within the art that the primary failure methods of high performance connecting rods are the following: propagation of a preexisting flaw in the component due to application of internal, compressive, tensional, torsional, sheer, thermal, and cyclical stresses (all of which are referred to jointly as “the failure stresses”); deformation or movement of the cap; loss of adequate oil lubrication to the wrist pin thereby causing it to seize to the connecting rod, and physical contact of the connecting rod with other engine components such as the camshaft or cylinder block. It would be desirable to provide a connecting rod that has an improved combination of strength, hardness, lubricity, and resistance to heat and corrosion so as to increase the longevity of operation and to increase the power output per unit displacement requirements of the connecting rod. The present invention provides an improved optimum combination of these properties via a combination of structural features and processing methods.

### BRIEF SUMMARY OF THE INVENTION

The present invention is a connecting rod assembly for use in a high performance engine. The assembly has a configuration of a substantially parallel sided elongate member, and a pair of rod bolts positioned for fastening the cap to the elongate member disposed at a splayed angle with the longitudinal axis so as to stabilize the attachment of the cap to the elongate member. The invention further includes electrochemically processing the aluminum alloy connecting rod components in order to form a layer of aluminum oxide matrix on the surface, and sealing the interstitial cavities of the matrix with an inert fluoropolymer to provide a composite providing added surface hardness and lubricity to decrease seizing and deformation of the connecting rod.

### BRIEF DESCRIPTION OF THE DRAWINGS

FIG. 1 illustrates a front view of a cross section of the connecting rod assembly lying in the plane.

FIG. 2 illustrates a front view of the same connecting rod assembly.

### DETAILED DESCRIPTION

The present invention is a new connecting rod having several different characteristics, some of which are pure structural features independent of the type of material used and other features that depend on using an aluminum alloy for their implementation. It will be apparent from the description when an aluminum alloy is necessary. However, aluminum alloys are preferable for use in high performance connecting rods due to their high elastic strength in overcoming the twisting and tortuous stresses imparted from the engine.

The aluminum alloy used in the present invention is preferably chosen from the 7000 series of alloys, under the AISI system for classifying alloy formulations. Examples of suitable 7000 series aluminum alloys exhibiting excellent qualities include 7075-T6511, 7050-T6, and 7055-T77511, with the 7075-T6511 alloy being most preferable.

The aluminum alloy components of the present invention are preferably made via the well known billet machining method using either extruded or cold finished plate stock which is completely machined into the finished connecting rod. The use of cold finished bar material is the ideal embodiment of this invention due to the tighter metal grain structure provided thereby. However, other useful methods of forming the aluminum alloy in the present invention include casting (molding from molten state), powdered metal manufacturing (compressing powder in die), and forging (compressing heated slug in die). All of these methods are well known in the art.

In the preferred cold billet machined embodiment of the present invention, the material is saw cut to an appropriate length and machined leaving an additional 0.02 inches of material on all surfaces to be finish machined in a later process. This initial rough machining removes the naturally occurring internal stresses of the billet allowing the finish machining operation to leave the connecting rod with the absolute minimum of manufacturing induced or naturally occurring internal stresses possible.

The initial rough-machined connecting rod preferably includes the cap as an integral part thereof. The cap is then removed from the forked elongated body by any of several methods which are conventional to the art, including sawing, laser cutting, and fracturing, preferably sawing.

The present connecting rod utilizes a particular structural relationship between the elongate rod body, the cylindrical crank pin bore, and the rod bolts to increase the stability of side-to-side movement between the cap and the fork end of the elongate body. The present connecting rod is an assembly of a forked elongate body, an arcuate cap, and a pair of rod bolts.

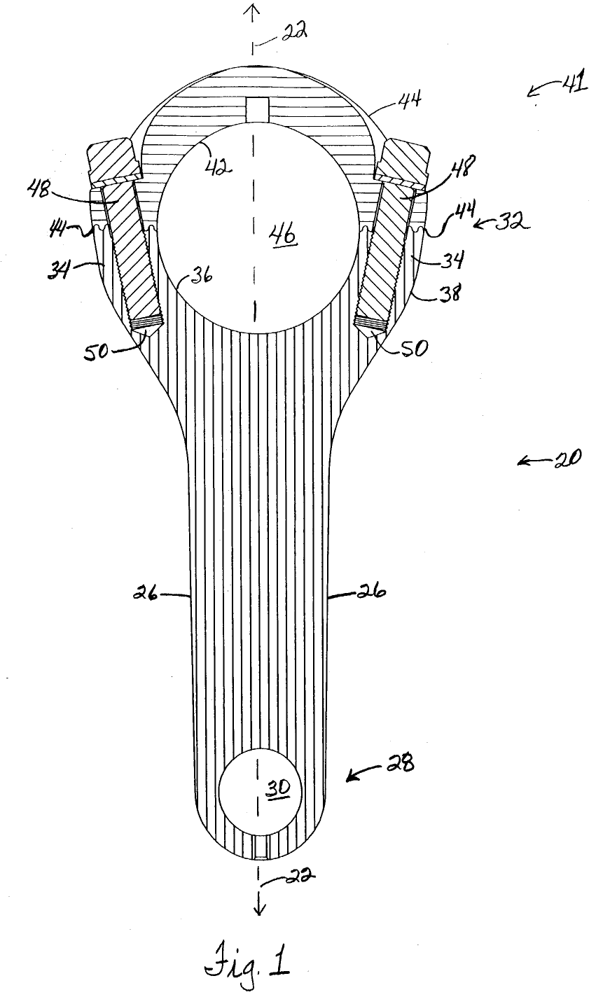

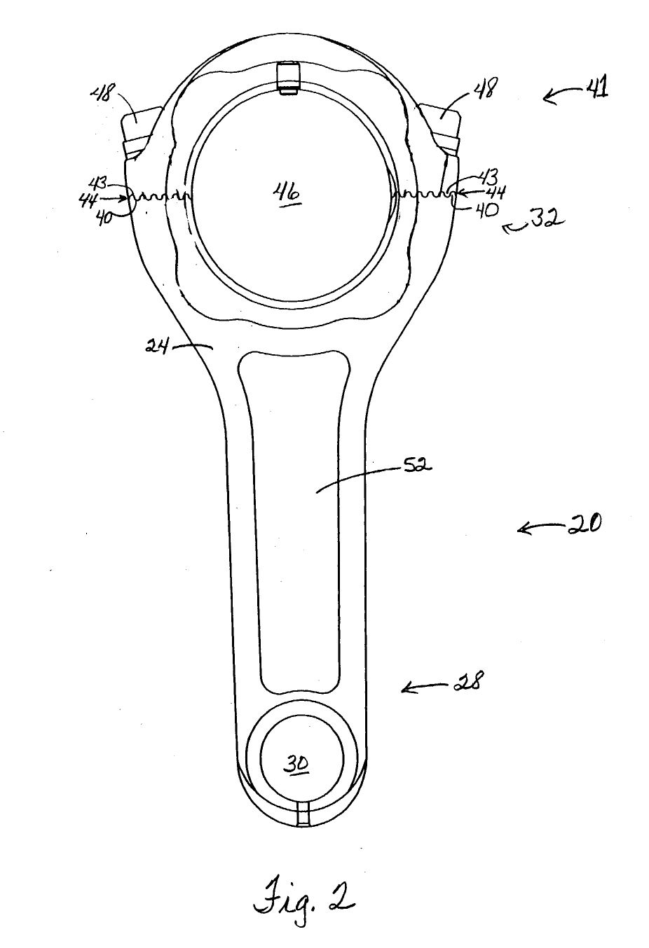

With reference to FIG. 1 and FIG. 2, the elongate body 20 lies in a plane and has a longitudinal axis 22 in the plane. The body has a front surface 24 and a rear surface with a first thickness therebetween. Two elongate sides 26 lie substantially parallel to (within a 10 degree angle of parallel) the longitudinal axis 22 at a distance therefrom. The first end (pin end) 28 defines a wrist pin bore 30 centered about a first bore axis transecting the longitudinal axis at an angle perpendicular to the plane. An opposite second end (crank end) 32 has two curved branches 34 each extending upwardly along the plane and disposed oppositely across the longitudinal axis forming an arcuate fork having a semi-cylindrical inner surface 36 and an arcuate outer surface 38. The fork terminates at two fork ends 40 which are machined to connect to the corresponding cap ends.

The arcuate cap 41 has a front surface, a rear surface, a semi-cylindrical inner surface 42, an arcuate outer surface, and two cap ends 43. Each of the surfaces of the arcuate cap correspond to the fork so that, upon connecting the two cap ends with the two fork ends, an annulus connected at two interfaces 44 is formed.

The annulus so formed by the connection of the cap and fork has a front surface, a rear surface, and defines a crank pin bore 46 centered about a second bore axis transecting the longitudinal axis at an angle perpendicular to the plane. The crank pin bore preferably has a radius greater than the distance of each of the sides of the body from the longitudinal axis.

Positioning the cap and fork together at the interface 44, the two components include a pair of channels disposed oppositely across the longitudinal axis between the front surface and the rear surface of the annulus. Each channel is sufficiently threaded between the interface and the channel end so to engagingly receive a rod bolt 48. Each of the channels extends from the outer surface of the arcuate cap across the interface and into the fork to a channel end. Each of the channels is centered about a line intersecting the longitudinal axis proximate the first end of the elongate body, instead of being parallel to the longitudinal axis, as is customary. Thus, the rod bolts received into the channels are disposed at a splayed angle from the longitudinal axis. Alternatively, the channels are splayed in the opposite direction so that the channel extends from the outer surface of the fork end of the elongate body across the interface and into the cap to a channel end in an angle intersecting the longitudinal axis in the plane at a point above the cap. The channels are disposed in the connecting rod to engagingly accommodate rod bolts having a threaded portion of preferably between 1.5 to 3 times the major thread diameter.

This configuration is optimum for reducing cap movement, as compared to the traditional parallel bolt configuration, due to the fact that the present connecting rod is connected together by relatively long threaded bolt ends positioned in the strongest portion of a substantially-parallel sided elongate body, the stronger central portion. It is preferable that the rod bolts are positioned so that the bolt ends 50 are disposed in the center portion of the elongate rod at a distance from the longitudinal axis less than the radius of the crank pin bore. A further important benefit of the present configuration is that the splayed rod bolts provide a clamping tension and compressional force to positively locate the cap with relation to the fork in resistance to deleterious side to side movement. The traditional parallel bolt configuration does little to directly counteract forces moving the cap from side to side.

While the interconnecting relationship between each corresponding set of fork ends and arc ends as shown in FIG. 1 is certainly preferred over an essentially straight or uneven mating relationship, the breakage of the tips of the interconnecting protrusions of the fork ends and arc ends along the interface 44 is greatly reduced with the present configuration.

Further, FIG. 2 illustrates the preferred embodiment of the elongate body wherein a portion 52 of the elongate body between the two elongate sides is thinner in order to reduce the weight of the piece without compromising the longitudinally directed strength. A further structural characteristic which is not claimed herein but which further strengthens the interface between the cap and fork is for each of the protrusions to be machined on a cross section so that an end view of the cap shows a group of true opposing arcs, with the two cap ends serrated in arcs directed oppositely toward the longitudinal axis.

The present invention further provides for the addition of strength and lubricity to the aluminum alloy connector rod by the processing of the elongate member and cap in a manner to add a protective hard composite layer thereto. The present method provides a layer that is much stronger than a coating due to the fact that the aluminum alloy outer surface is oxidized, and thus transformed, to a harder aluminum oxide structure integral to the aluminum alloy. The method further includes filling the interstitial pores of the porous aluminum oxide matrix with a non-reactive fluoropolymer such as Teflon (polytetrafluoroethylene) to provide increased lubricity and corrosion resistance.

The present method is applicable only for aluminum alloy connecting rod components having a desired outer surface shape and outer surface dimensions for use as part of a connecting rod assembly. The method comprises first forming aluminum alloy connecting rod components (connecting rod body and cap) having an aluminum alloy outer surface so that the components embody the desired outer surface shape with outer surface dimensions slightly smaller than said desired outer surface dimensions. Any method of forming is suitable, but the billet machined method is preferred. The component pieces are then electrochemically treated with a mixture of water and an acid, using the aluminum alloy component piece as the anode. The electrical potential between the anode and cathode is sufficient to oxidize the aluminum alloy outer layer to form a porous outer aluminum oxide matrix. Anodization of aluminum is well known and described in general in the Encyclopedia of Electrochemistry of the Elements, Ed., Marcel Dekker, Inc., New York, which is incorporated herein by reference.

The acid used in the electrochemical oxidation is preferably a polybasic acid. Examples of preferred polybasic acids include sulfuric, oxalic, phosphoric, boric, salicylic, sulfonic, and phosphonic acids, with sulfuric acid being the most preferable acid.

The pores of the resulting aluminum oxide matrix layer are then sealed with a fluoropolymer such as Teflon by known infusion techniques such as spraying, bathing, soaking, etc. The infusion process is performed at a high temperature below the tempering temperature of the aluminum alloy core, preferably within 75 to 45 degrees of the tempering temperature of the alloy.

It is important to understand that since the oxidation of the aluminum surface of the pieces results in a “growth” of the surface as the surface aluminum atoms realign in a more ordered arrangement, the surfaces must be left about 0.001 inches small, the threaded channels must be roll formed about 0.005 inches oversize, and the bores must be machined about 0.0022 inches small, depending on the alloy used. The composite layer formed is preferably between 0.001 and 0.005 inches thick. It should be appreciated that the machined dimensions of the aluminum alloy component pieces must be determined as a function of the alloy and the process conditions, on a case by case basis so that the final surface dimensions are the desired dimensions for use in the connector rod assembly.

The present process provides a connector rod having an aluminum alloy core that provides the strength and elasticity needed, and an aluminum oxide fluoropolymer composite outer shell providing increased hardness (for reduing deformation) and lubricity (for decreasing seizing), as well as added corrosion resistance. When the structural configuration of splayed bolts (for decreasing cap movement) is combined with the composite layered aluminum alloy, the resulting connector rod has significantly increased longevity.

The invention has been described in detail with particular reference to preferred embodiments thereof, but it will be understood that variations and modifications can be effected within the spirit and scope of the invention.

1. A connecting rod assembly comprising:
(a) an elongate body lying in a plane and having a longitudinal axis in the plane, said body having a front surface and a rear surface with a first thickness therebetween, two elongate sides each lying substantially parallel to the longitudinal axis at a distance therefrom, a first end defining a wrist pin bore centered about a first bore axis transecting the longitudinal axis at an angle perpendicular to the plane, an opposite second end having two curved branches each extending upwardly along the plane and disposed oppositely across the longitudinal axis forming an arcuate fork having a semi-cylindrical inner surface and an arcuate outer surface, said fork terminating at two fork ends;
(b) an arcuate cap having a front surface, a rear surface, a semi-cylindrical inner surface, an arcuate outer surface, and two cap ends, each of the surfaces of said arcuate cap corresponding to said fork so that, upon connecting the two cap ends with the two fork ends, an annulus connected at two interfaces is formed, said annulus having a front surface, a rear surface, and defining a crank pin bore centered about a second bore axis transecting the longitudinal axis at an angle perpendicular to the plane;
(c) a pair of channels disposed oppositely across the longitudinal axis between the front surface and the rear surface of said annulus, each of said pair of channels extending from the outer surface of the arcuate cap across the interface and into the fork to a channel end, each of said channels being threaded between said interface and said channel end so to engagingly receive a rod bolt, wherein each of said channels is centered about a line intersecting the longitudinal axis at a point proximate the first end of the elongate body; and
(d) a pair of rod bolts engagingly receivable into said pair of channels so as to fasten said arcuate cap to said elongate body, each of said rod bolts having a threaded portion having a diameter and a threaded length extending from said interface through said channel for a length to a bolt end.

2. The connecting rod assembly according to claim 1 wherein, when assembled, each of said rod bolts is positioned so that the bolt end is disposed at a distance from the longitudinal axis less than the radius of said crank pin bore.

3. The connecting rod assembly according to claim 1 wherein the length of the threaded portion of each of said pair of fastening bolts is between 1.5 to 3 times larger than the thread diameter.

4. The connecting rod assembly according to claim 1 wherein a thin area of said elongate body between said two elongate sides and also between said wrist pin bore and said crank pin bore has a second thickness less than said first thickness, each of said bolts being is disposed outside of said thin area.

5. The connecting rod assembly according to claim 1 wherein each said interface is formed by a interconnecting relationship between each corresponding set of said fork ends and said arc ends.

6. The connecting rod assembly according to claim 1 wherein said elongate body and said arcuate cap are formed from an aluminum alloy core.

7. The connecting rod assembly according to claim 6 wherein said aluminum alloy core has a thin outer layer of a composite of aluminum oxide and a fluoropolymer integrally connected thereto.

8. A connecting rod assembly comprising:
(a) an elongate body lying in a plane and having a longitudinal axis in the plane, said body having a front surface and a rear surface with a first thickness therebetween, two elongate sides each lying substantially parallel to the longitudinal axis at a distance therefrom, a first end defining a wrist pin bore centered about a first bore axis transecting the longitudinal axis at an angle perpendicular to the plane, an opposite second end having two curved branches each extending upwardly along the plane and disposed oppositely across the longitudinal axis forming an arcuate fork having a semi-cylindrical inner surface and an arcuate outer surface, said fork terminating at two fork ends;
(b) an arcuate cap having a front surface, a rear surface, a semi-cylindrical inner surface, an arcuate outer surface, and two cap ends, each of the surfaces of said arcuate cap corresponding to said fork so that, upon connecting the two cap ends with the two fork ends, an annulus connected at two interfaces is formed, said annulus having a front surface, a rear surface, and defining a crank pin bore centered about a second bore axis transecting the longitudinal axis at an angle perpendicular to the plane;
(c) a pair of channels disposed oppositely across the longitudinal axis between the front surface and the rear surface of said annulus, each of said pair of channels extending from the outer surface of the arcuate fork across the interface and into the arcuate cap to a channel end, each of said channels being threaded between said interface and said channel end so to engagingly receive a rod bolt; and
(d) a pair of rod bolts engagingly receivable into said pair of channels so as to fasten said arcuate cap to said elongate body, each of said rod bolts having a threaded portion having a diameter and a threaded length extending from said interface through said channel for a length to a bolt end.

9. The connecting rod assembly according to claim 8 wherein the length of the threaded portion of each rod bolt is between 1.5 to 3 times the thread diameter.

10. A method of manufacturing aluminum alloy connecting rod components having a desired outer surface shape and outer surface dimensions for use as part of a high performance connecting rod assembly, comprising:
(a) forming aluminum alloy connecting rod components having an aluminum alloy outer surface so that said components embody said desired outer surface shape with outer surface dimensions slightly smaller than said desired outer surface dimensions, said components consisting of a connecting rod body and corresponding cap;
(b) contacting the aluminum alloy outer surface of each of the components with a mixture of water and an acid and imposing an electrical potential between the component as the anode and a cathode, where the electrical potential is sufficient to oxidize said aluminum alloy outer layer thus forming an outer aluminum oxide matrix defining pores therein; and
(c) sufficiently infusing the pores of the aluminum oxide matrix with a fluoropolymer at a high temperature below the tempering temperature of the aluminum alloy to provide a non-porous composite layer having a composite outer surface having said desired outer surface shape and outer surface dimensions.

11. The method according to claim 10 wherein said acid is a polybasic acid.

12. The method according to claim 11 wherein said polybasic acid is selected from the group consisting of sulfuric acid, oxalic acid, phosphoric acid, boric acid, salicylic acid, sulfonic acid, and phosphonic acid.

13. The method according to claim 10 wherein said composite layer has a thickness of between about 0.001 and 0.005 inches.

14. The method according to claim 10 wherein the fluoropolymer is polytetrafluoroethylene.

15. The method according to claim 9 wherein said connecting rod body and corresponding cap include a pair of channels adapted for receiving rod bolts for fastening the cap to the connecting rod body in a position that is splayed toward a longitudinal axis lying along the rod body.

16. A connecting rod formed from an aluminum alloy and covered with an integrally connected layer of a composite of aluminum oxide and a fluoropolymer.

17. The connecting rod according to claim 16 wherein said fluoropolymer is tetrafluoroethylene.
